(19) United States
(12) Patent Application Publication
(10) Pub. No.: US 2002/0082957 A1
(43) Pub. Date: Jun. 27, 2002

(54) Real-time reagent usage control system for clinical and diagnostic laboratories

(75) Inventor: Igor Krassi, North Hollywood, CA (US)

Correspondence Address: ROSS A. SCHMITT, c/o LADAS & PARRY, Suite 2100, 5670 Wilshire Boulevard, Los Angeles, CA, 90036-5679, US

(73) Assignee: UNITED BUSINESS DEVELOPMENT

(21) Appl. No.: 09/746,308

(22) Filed: Dec. 21, 2000

(51) Int. Cl. G06F 17/60

(52) U.S. Cl. 705/29; 705/28

(57) ABSTRACT

A system and method for tracking usage of reagent products by clinical and disgnostic laboratories. A reagent control system receives test information from one or more test instruments while the instruments are performing tests using reagents or upon the completeion of those tests. Test definitions have been constricted which define the types of tests run and the reagents used by each of those tests. The reagent control system then calculates the amounts of reagents used based upon the tests that were run and the difinitions of those tests. The reagent control system maintains databases that define inventory status of reagents, the status of purchase orders for additional reagents, and the shipping status of those reagents. The reagent control system may be deployed as a standalone application allowing access to local users only or it may be deployed as a web-based application allowing access to the system to autorized users via Internet connections.

### FIELD OF THE INVENTION

The present invention is a computerized software system for clinical and diagnostic laboratories that utilize reagent products in testing. The present invention is a real-time reagent usage control system, which captures, displays and reports usage of reagent products, as they are used; test-by-test. The present invention may be used as an on-line service as well as a stand-alone system.

### BACKGROUND OF THE INVENTION

Clinical and diagnostic laboratories use large amounts of chemical reagents when performing tests on blood, urine, tissue samples, and other human body products. The performance of these tests within a short schedule is often critical to determining a person's health. The performance of these tests within allotted schedules are often impacted by the non-availability of the necessary reagents required for these tests. Hence, it is extremely important that the laboratories have on hand all the reagents required to perform the tests performed by the lab.

Some laboratories keep large amounts of the reagents on hand and make periodic orders, such as monthly or bimonthly orders, to replenish their stock. This manner of tracking and ordering reagents may be extremely inefficient, as the laboratory may be faced with having a large stock of reagents that are only infrequently used, while the stock of the more frequently used reagents may be depleted before a new order is made.

Other laboratories use a manual inventory process to track the usage of reagents. This process simply involves a person checking to see what reagents are present on the shelves used to stock the reagent inventory. However, since this process requires a person to check or track inventory, it is likely that mistakes will be made as to the quantities of reagents on hand. These mistakes are also more likely to occur when the laboratory is extremely busy, such that shortages of certain critical reagents will be overlooked. Such shortages of critical reagents will likely result in delays to critical tests.

Thus, there exists a need in the art for tracking the usage of reagents by clinical and diagnostic laboratories to provide improved control over the reagent inventory.

### SUMMARY

It is an object of the present invention to provide for automatic collection and tracking of usage of reagents by test instruments used within clinical and diagnostic laboratories. Another object of the present invention to provide for reagent tracking while reagents are being used or immediately after the use of reagents. Another object of the present invention to provide for automatic placement of orders for required reagents and to also track the shipping status of ordered reagents. Another object of the present invention to provide for reagent tracking for multiple test instrument installations. Another object of the invention to provide local access reagent tracking information to one or more users. Another object of the invention is to provide one-line access to reagent tracking information, either as a separate on-line service or as part of a larger on-line service, where one or more users can access the information via the Internet.

Other objects and advantages of the present invention will become apparent from the following description and accompanying drawings. The present invention is a real-time computerized reagent usage control system, which captures, displays, analyses, and reports usage of reagent products by a clinical or diagnostic laboratory.

A first embodiment of the invention is provided by a reagent control system for tracking reagent usage, the system receiving commands from one or more users and providing information on reagent status and receiving test data from instruments performing tests in which reagents are used, the system comprising: a communications module receiving the commands and test data; a test definition catalog module storing and processing test definition data about individual tests using reagents; an inventory control module storing and processing information about inventory totals for reagents; a data analyzer module analyzing and managing all data received as input to the system or created by modules within the system; and a parsing module coupled to the communication module, the test definition module, the inventory control module, and the data analyzer module, the parsing module controlling the transfer of information between the modules. Preferably, the system receives the test data in real-time while the tests instruments are performing their tests or immediately upon completion of their tests. The system may also comprise additional modules such as a security/customization module that limits user access to the system, a purchase order module that maintains and updates a database of purchase orders issued for required reagents and a shipping module that maintains and updates a database of reagents that have been ordered. The system may be embodied as a standalone system that supports local users or the system may provide access to multiple users from web-browsers connected to the Internet, thus allowing any one with Internet or Word Wide Web access and access to the system to track the usage of reagents.

Another embodiment of the present invention is provided by a method for tracking reagent usage by one or more laboratory test instruments using reagents to perform tests, the method comprising the steps of: receiving commands from one or more users specifying test information for each test performed by the one or more test instruments; generating test definition data from the test information; receiving test data from each one of the one or more test instruments;; analyzing the test data with the test definition data to produce reagent usage data; and reporting the reagent usage data to the one or more users. The method may additionally comprise the steps of determining if additional reagent quantities are needed, ordering those reagents, and tracking the shipment of those reagents.

Another embodiment of the present invention is provided by a computer program embodied on computer-readable medium for tracking the usage of reagents by test instruments in clinical or diagnostic laboratories, the computer program comprising: a communication module source code segment comprising instructions for receiving and sending communication data using data transfer protocols; a test definition module source code segment comprising instructions for defining, storing, and providing test definition data for an individual test; an inventory control module source code segment comprising instructions for storing, updating, and providing reagent inventory data for reagents used in individual tests; a data analyzer module source code segment comprising instructions for analyzing communication data, test definition data, and inventory control data; and a parsing module source code segment comprising instructions for analyzing data received from the communication module, the test definition module, and the data analyzer module and routing the data to the appropriate module based on the analysis of the data. The computer program may have additional source code segments comprising a security/customization module for limiting access to the program, a purchase order module for placing and tracking reagent purchase orders, and a shipping module for tracking shipments of ordered reagents.

### BRIEF DESCRIPTION OF THE DRAWINGS

FIG. 1 is a flowchart illustrating data flow as provided by one embodiment of the present invention, demonstrating data flow from a test instrument installation to and within the system provided by the present invention.

FIG. 2 illustrates additional modules within the system provided by the present invention and illustrates the system deployed as a stand-alone application.

FIG. 3 illustrates the system provided by the present invention deployed as an on-line service.

FIG. 4 illustrates the system provided by the present invention incorporated within a larger on-line service

### BRIEF DESCRIPTION OF THE APPENDIX

Appendix A from pages A1 to A26 contains the operation manual for a preferred embodiment of the present invention as provided by the REACSym™ software program.

### DETAILED DESCRIPTION OF THE PREFERRED EMBODIMENTS

The present invention works as a process of utilizing individual test definitions created for a specific clinical or diagnostic laboratory. By incorporating these test definitions and incorporating real-time data relating to specific tests, the invention accounts for the inventories of remaining reagents. In particular, the present invention determines the point when the inventory of specific reagents is low and generates multiple warning forms as such reorder points approach. In addition, the present invention tracks and reports on purchase order and delivery activity, stock on hand, life-cycle maintenance, test and workflow analysis, and secure client account activity.

A preferred embodiment of the present invention is a reagent usage control system as embodied by the REACSym™ software program. Appendix A provides the Operations Manual for the REACSym™ program. However, other embodiments of the present invention may be provided by other software programs or hardware and software systems according to the disclosure of the present invention provided below. Hence, the present invention is not limited to the embodiment provided by the REACSym™ program.

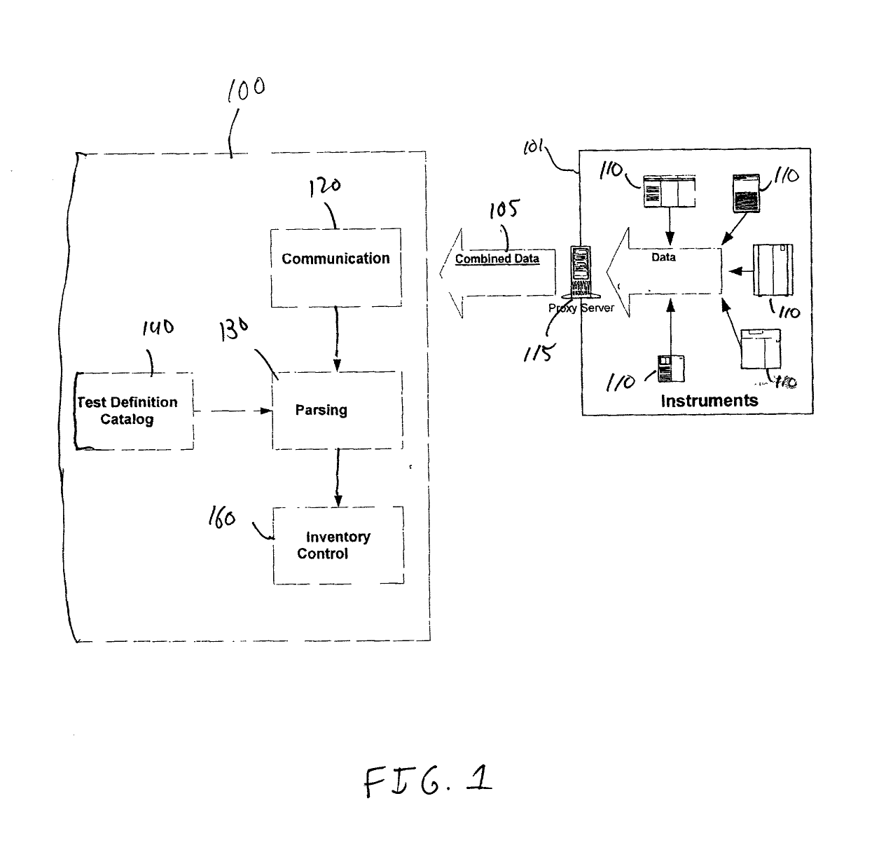

FIG. 1 shows a simplified block diagram illustrating the major components of a reagent usage control system 100 according to the present invention. As shown in FIG. 1, combined data 105 may be received from multiple test instruments 110 contained within a test instrument installation 101. A proxy server 115 may be used to connect to each of the test instruments 110 and to collect data from each of the test instruments. The combined data 105 comprises data received from the instruments 101 in real-time and may comprise a vendor specific proprietary test identification number, the purpose of the test, and the status of the test, such as whether the test is a first run, a repeat of a test, a successful or unsuccessful test, and an indication of the calibration status of the instrument 101. Note, however, that a proxy server is not required for the reagent usage control system 100. The multiple test instruments 110 may send their individual data directly to the reagent usage control system 100. Other test instrument installations 101 may use a Laboratory Information System (LIS) to set-up and control the test instruments 110 within the installation 101. The reagent usage control system 100 may then be coupled to one or more Laboratory Information Systems to receive combined data 105 from one or more test instrument installations 101.

As shown in FIG. 1, the combined data 105 is then provided to a Communication module 120. The Communication module 120 then provides the Combined Data 105 to a Parsing module 130. The Parsing module 130 processes the Combined Data 105 with data received from the Test Definition Catalog 140. Data from the Test Definition Catalog 140 may include laboratory specific proprietary test definition information such as what reagents are used in a test and in what specific quantities. Based on the processing performed by the Parsing Module 130 data is sent to the Inventory Control Module 160 to define the inventory status of reagents. The inventory status information may include reagent identification number, quantity of the reagent and the stock status of that reagent.

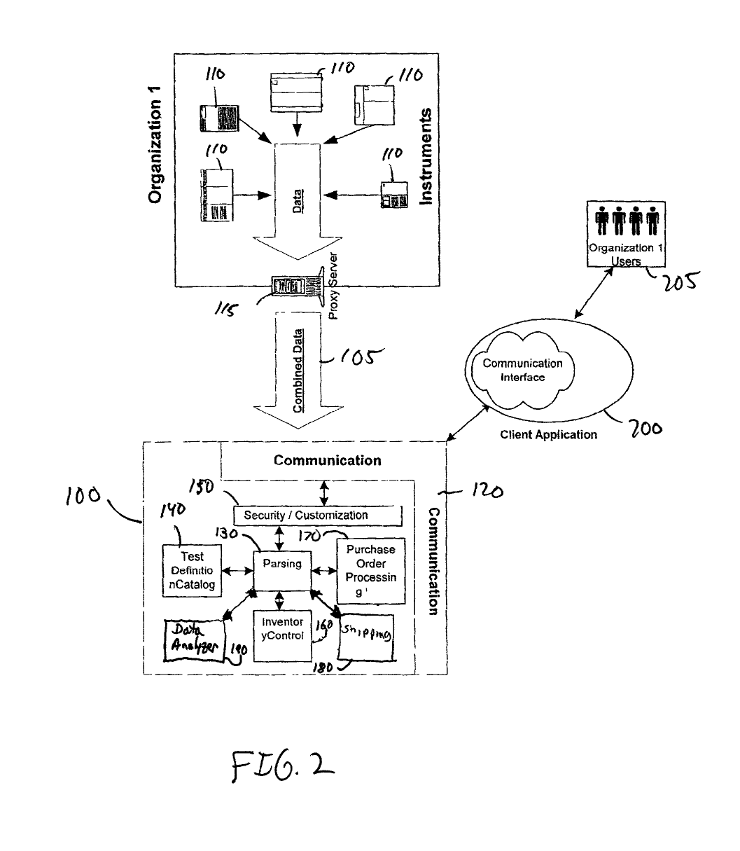

FIG. 2 illustrates a reagent usage control system 100 according to the present invention deployed as a standalone application and also illustrates additional modules that may be used. Multiple users 205 may interface to the reagent usage control system 100 through a communication interface 200 that couples to the Communication Module 120. FIG. 2 shows a Security/Customization Module 150 to process information received from the Communication Module 120. FIG. 2 also shows a Purchase Order Processing Module 170 that provides for processing of purchase orders. Note also that FIG. 2 shows the information flows as both flowing to and from the Parsing Module 130, which allows the Parsing Module to pass information between the other modules.

The individual modules of the reagent usage control system will now be further described. Note that for purposes of the following, the word ‘Parsing’ is a word standard within the programming community and is meant as extracting a piece or a section of data from a larger group of data.

The Test Definition Catalogue Module 140 allows the end-user to create, edit, delete and view the description of the test. The reagent usage control system 100 works as a process of utilizing individual test definitions. By entering all items that belong to their particular test definitions, the test itself is created. By incorporating these test definitions, from which real-time data is automatically created (relating to the specific tests), the module 140 accounts for the inventories of the remaining items.

When creating a new test, the end-user would be required to provide the necessary and the unique information to that particular test; such as the correct test ID, the test name, the cost per test and the components of the test (reagents and their quantity that are used to perform their particular tests), which will all be processed by the use of the Parsing Module of the application. The Test Definition Catalog Module 140 will also provide a “Report Finished Test” feature, which will allow the end-user to manually enter the result of the finished tests, and automatically update the database.

The Parsing Module 130 is responsible for analyzing data received from the Communication Module 120, parsing data accordingly to the data type and rerouting Parse components along with generated instructions (only of needed) to the appropriate modules.

The Communication Module 120 allows the invention to receive and to send data using different kinds of protocols like TCP/IP, HTTP, ASTM, and WAP.

The Inventory Control Module 160 allows the end-user to edit the inventory stock.

The Purchase Order Processing Module 170 allows the end-user to create, edit, delete, find, and register received orders in the active, pending and completed pay order database.

An ID and password may assigned to an end-user of the reagent usage control system. The Security/Customization Module 150 provides the capability to assign the ID and password and to limit access to the system to valid users. The Security/Customization Module 150 also provides the capability for the application to behave differently according to the user's ID and assigned privileges.

A Shipping Module 180 allows an end user to create, edit, delete, find, register shipped orders in the active, pending and completed ship order database. A Data Analyzer Module 190 is designed to analyze, manage and control all available data in the system for the purpose of generating a wide range of necessary reports. By collecting a sufficient amount of data, and based upon the time frame specified by the end-user, the module will automatically evaluate the minimum and maximum amount of the specific reagents required in stock at the time of placing an order. Additionally, the module analyzes, manages and controls all data related to the tests (successful, repeats/wastes, controls & calibrators) and generates a range of reports related to these individual tests.

A typical embodiment of the reagent usage control system is a server-side application written in computer programming language of choice. Use of the JAVA programming language is preferred because it enables the system to run on any hardware platform that supports Java Virtual Machine.

The software architecture of the system has a three-tier (or three-layer) architecture discussed below

The first Tier of the application performs a function of transferring the data to and from the end-user (hereafter referred to as the “human interface layer”). The transfer from the end-user consists of receiving data, which may be entered by the end-user either manually or automatically, by connecting the system to the medical testing equipment. Upon receiving data from the end-user, human interface layer transfers data to the second application layer. The human interface layer is also designed to receive the analytical results of the system's function.

The transfer of data to the end-user consists of down-loadable and printable reports, graphs, and charts.

The human interface layer may utilize the following existing technologies:

(a) Java Web Server—application that provides capability to communicate with user via HTTP protocol.

(b) HTML for static data presentation;

(c) JAVA for dynamic data presentation, including,

(i) JAVA Server Pages—JAVA code embedded into an HTML page,

(ii) (ii) JAVA Servlets—specialized objects capable of communicating with a web server.

The second Tier of the software architecture (referred also to as the “Business Rules Layer”) is a collection of objects that possess the knowledge of algorithms for verifying, evaluating and processing data. The Business Rules layer performs functions of receiving and validating input data, processing received data and passing results back to the Human Interface. The Business Rules layer may be created by utilizing standard Java Beans specification.

The third Tier of the software architecture (hereafter referred to as the “Database Layer”) relates to the storage of the information and data manipulated for tracking reagent usage. This Tier is, in turn, may be segregated into two functional parts: (a) Java Database Connectivity Application Programming Interface which is a collection of objects capable of communicating with the database using standardized Sequel Query Language (SQL); and (b) “MySql” relational database management system. The Database Layer performs the function of storing and retrieving relational data and processing queries provided by the objects of the Business Rules layer.

The two parts of the Database layer may be located on the same or different servers. In the typical embodiment, these two parts are located on two different servers. However, the number of servers is not a limiting factor and invention can function on any number of servers.

In order to use the invention in its typical embodiment, the end user has to have: (a) a computer system, consisting of the hardware platform with the internet browsing capabilities, data entry devise, data display devise, and an active connection to any Internet Service Provider. Using such systems, the end-user obtains the data entry displays and enters data relating to diagnostic or medical tests. The data may be entered by the end-user manually or via a computerized data transfer protocol.

At any given time, the end-user may obtain reports describing the remaining reagent inventory. Also, during the real-time usage of the invention, the end-user will be prompted with warning screens in case of shortage of in the reagent inventory. Reports provided by the invention can be downloaded to the stand-alone computer system of the end-user or printed to the attached printer.

The reagent usage control system has the functionality of tracking the reagent inventory orders and the delivery of reagents. The functionality consists of display of order forms for the end users and the order tracking screens, showing the status of pending orders.

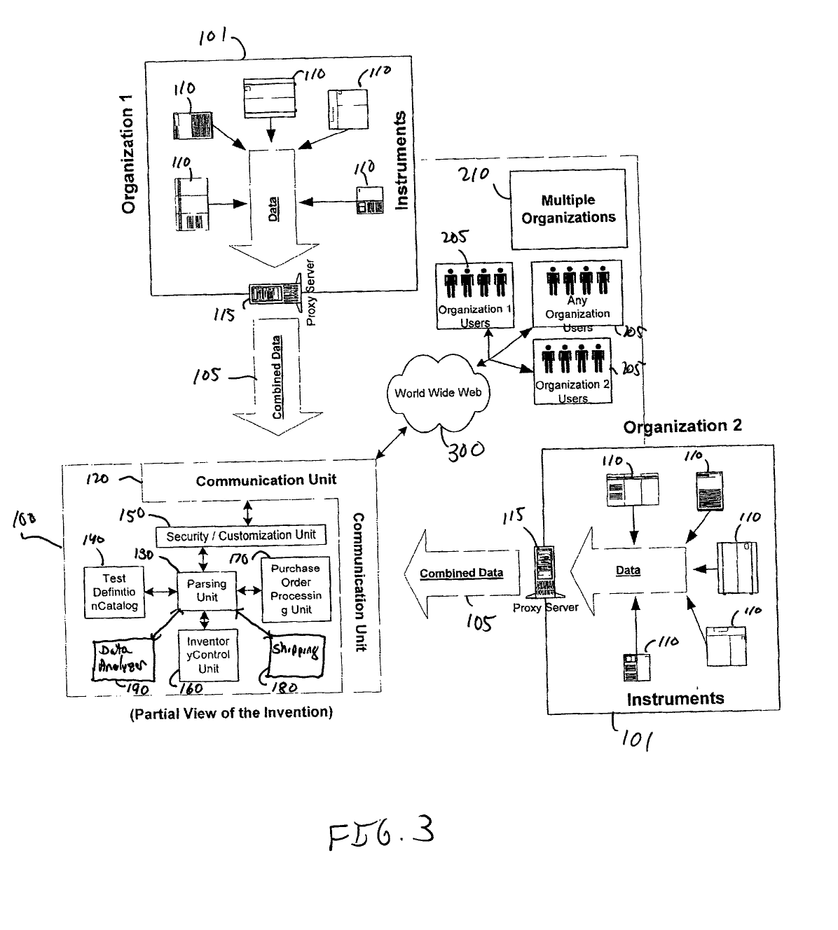

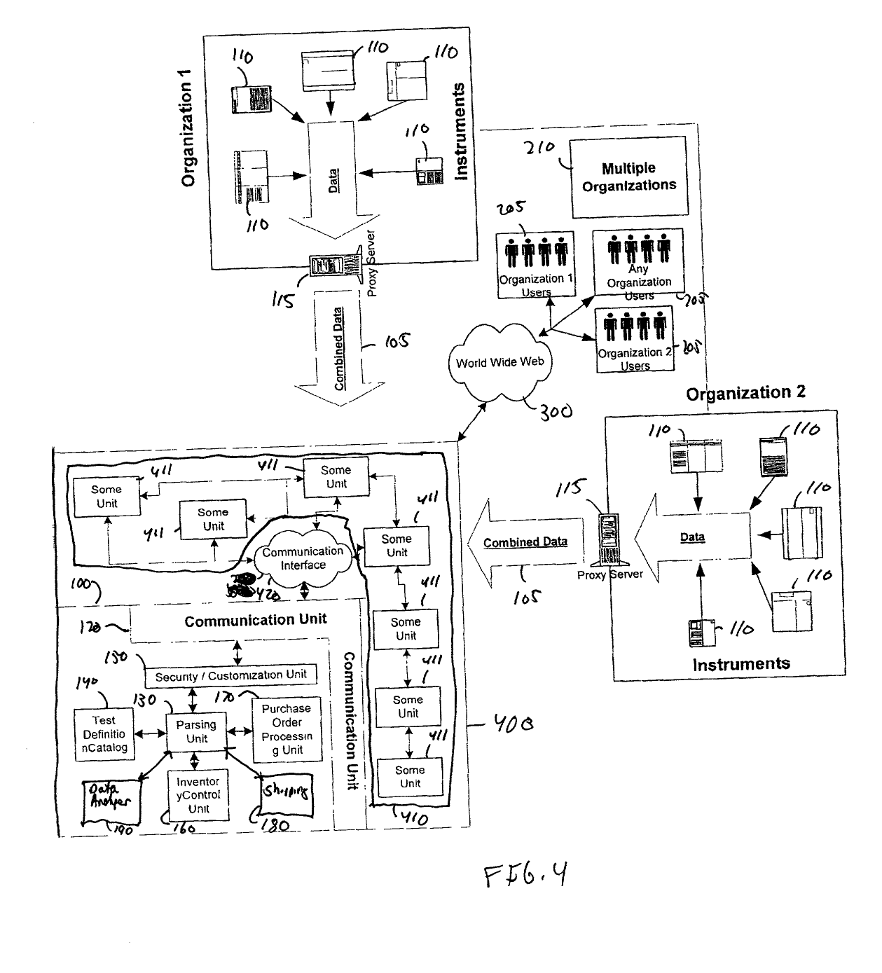

Alternative embodiments of the reagent usage control system according to the present invention may be deployed as an on-line service as shown in FIG. 3 or as part of a larger on-line service as shown in FIG. 4. In FIG. 3, the reagent usage control system 100 is coupled via the Communication Module 120 to the World Wide Web 300 for access to multiple users 205. FIG. 3 also shows that the reagent usage control system may support reagent control for multiple test instrument installations 101. Hence, the multiple users 205 or multiple organizations 210 have access to the features provided by the reagent usage control system 100 from any computer system connected to the World Wide Web 300.

FIG. 4 illustrates the deployment of the reagent usage control system 100 as a subsystem of a larger on-line service 400. The larger on-line service 400 comprises the reagent usage control system 100, other processing modules 411, and a communication interface 420 that provides communication among and between the other processing modules 411 and between the other processing modules 411 and the reagent usage control system. The other processing modules 411 may provide additional processing of the combined data received from the test instruments 110 or may provide other lab related processing. The larger on-line service 400 may be coupled to the World Wide Web 300 allowing access to the larger on-line service 400 from multiple users 205 or organizations. As shown in FIG. 4, the larger one-line service may receive data from multiple test installations 101.

From the foregoing description, it will be apparent that the present invention has a number of advantages, some of which have been described above, and others of which are inherent in the embodiments of the invention described above. Also, it will be understood that modifications can be made to the reagent control system described above without departing from the teachings of subject matter described herein. As such, the invention is not to be limited to the described embodiments except as required by the appended claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A reagent control system for tracking reagent usage, the system receiving commands from one or more users and providing information on reagent status and receiving test data from instruments performing tests in which reagents are used, the system comprising:
a communications module receiving the commands and test data;
a test definition catalog module storing and processing test definition data about individual tests using reagents;
an inventory control module storing and processing information about inventory totals for reagents;
a data analyzer module analyzing and managing all data received as input to the system or created by modules within the system; and
a parsing module coupled to the communication module, the test definition module, the inventory control module, and the data analyzer module, the parsing module controlling the transfer of information between the modules.

2. The reagent control system as claimed in claim 1, wherein the test data is received from the instruments performing tests in real-time while the instruments are performing tests.

3. The reagent control system as claimed in claim 1, the system further comprising:
a security/customization module coupled to the communication module and the parsing module, the security customization module receiving the commands and test data and providing different levels of access to the system depending upon the user from the commands are received.

4. The reagent control system as claimed in claim 1, the system further comprising:
a shipping module coupled to the parsing module, the shipping module processing information related to status of shipments from reagent vendors.

5. The reagent control system as claimed in claim 1, the system further comprising:
a purchase order module coupled to the parsing module, the purchase order module processing information related to vendor purchase orders.

6. The reagent control system as claimed in claim 1, wherein the reagent control system is a standalone software application executing on a computer system with a memory, the computer system being accessed by one or more users.

7. The reagent control system as claimed in claim 1, wherein the reagent control system is a software application executing on a computer system with a memory, the computer system being accessed by one or more users over a connection to the Internet.

8. The reagent control system as claimed in claim 1, wherein the system is a software application executing on one or more computer systems with memory, the reagent control system being part of another software application being accessed by one or more users over one or more connections to the Internet.

9. A method for tracking reagent usage by one or more laboratory test instruments using reagents to perform tests, the method comprising the steps of:
receiving commands from one or more users specifying test information for each test performed by the one or more test instruments;
generating test definition data from the test information;
receiving test data from each one of the one or more test instruments;
analyzing the test data with the test definition data to produce reagent usage data; and
reporting the reagent usage data to the one or more users.

10. The method as claimed in claim 9, wherein the step of receiving the individual test data is performed in real time while each one of the one or more test instruments performs a test.

11. The method as claimed in claim 9, further comprising the step of updating a reagent inventory database with the reagent usage data.

12. The method as claimed in claim 11, further comprising the steps of:
determining whether additional reagent quantities are required from the reagent inventory database; and
placing purchase orders for reagents for which additional reagents quantities are required.

13. The method as claimed in claim 9, further comprising the step checking commands received from an individual user to determine if that user is authorized to issue commands.

14. The method as claimed in claim 9, wherein one or more connections to the Internet are used to receive commands from users and to report reagent usage data to users.

15. The method as claimed in claim 9, wherein the method comprises software instructions processed on a computer system with memory, and the step of receiving commands from users is performed by a communication interface coupling user-entered commands to the computer system and the step of reporting the reagent user data is performed by the communication interface.

16. The method as claimed in claim 9, the method being a reagent usage software application comprising software instructions executing on a computer system with memory, and the steps of receiving commands from users and reporting reagent usage data are performed by a software communication interface, the software communication interface coupling the reagent usage software application to other software applications executing on the computer system.

17. The method as claim in claim 16, wherein the computer system is coupled to the Internet and the one or more users provide commands and receive reagent usage data from one or more web-browsers connected to the Internet.

18. A computer program embodied on computer-readable medium for tracking the usage of reagents by test instruments in clinical or diagnostic laboratories, the computer program comprising:
a communication module source code segment comprising instructions for receiving and sending communication data using data transfer protocols, the communication data comprising test data received from the test instruments, commands from users, and information provided to users;
a test definition module source code segment comprising instructions for defining, storing, and providing test definition data for an individual test;
an inventory control module source code segment comprising instructions for storing, updating, and providing reagent inventory data for reagents used in the individual tests;
a data analyzer module source code segment comprising instructions for analyzing communication data, test definition data, and inventory control data; and
a parsing module source code segment comprising instructions for analyzing data received from the communication module, the test definition module, and the data analyzer module and routing the data to the appropriate module based on the analysis of the data.

19. The computer program as claim in claim 18, the computer program further comprising:
a security/customization module source code segment comprising instructions for assigning an ID and password to users of the computer program and limiting access to the computer program to valid users.

20. The computer program as claim in claim 18, the computer program further comprising:
a purchase order module source code segment comprising instructions for storing, updating, and providing purchase order data for reagents to be ordered and reagents received; and
a shipping module source code segment comprising instructions for storing, updating, and providing shipping data for ordered reagents,
wherein the purchase order module and the shipping order module receive data from the parsing module and send data to the parsing module and the data analyzer module analyzes the purchase order data and the shipping data.
